(19) United States
(12) Patent Application Publication
(10) Pub. No.: US 2023/0134426 A1
(43) Pub. Date: May 4, 2023

(54) SCALING AND PROVISIONING PROFESSIONAL EXPERTISE

(71) Applicant: Bloom Value Corporation, Norwalk, CT (US)

(72) Inventors: Arun Hampapur, Norwalk, CT (US); Sampoorna Hegde, Bengaluru (IN); Venu Kondle, West Sacramento, CA (US); Arvind Conjeevaram, Bangalore (IN); Haripriya Jagirdar, Bangalore (IN)

(73) Assignee: Bloom Value Corporation, Norwalk, CT (US)

(21) Appl. No.: 17/894,187

(22) Filed: Aug. 24, 2022

(30) Foreign Application Priority Data
Aug. 24, 2021 (IN) 202141038327

(51) Int. Cl. G06Q 10/0631

(52) U.S. Cl. CPC G06Q 10/063112; G06Q 10/063114

(57) ABSTRACT

System and method for scaling up an access to a professional expert, in real time or on demand, is described. In one aspect, the system may include a communicatively couple arrangement of multiple input data sources, an artificial intelligence (AI) mediated multimodal communication system (MMCS), a professional experts system, and external data sources. The AI MMCS may receive data or information in multiple formats from the input data sources, process the received data, and based on multiple attributes, such as a domain area, skills, areas of expertise, availability, etc., the AI MMCS may facilitate connecting with a professional expert. When the professional expert of is unavailable or unable to provide a further improvised resolution, the AI MMCS may, execute operations to make determinations and provide access to a next level of professional expert who may provide resolution/remediation to the end user.

### CROSS REFERENCE TO RELATED APPLICATIONS/INCORPORATION BY REFERENCE

This application claims the priority benefit of an Indian Provisional Patent Application number 202141038327, filed on Aug. 24, 2021, The contents of the aforementioned application is incorporated herein by reference in its entirety.

### FIELD

Various embodiments of the disclosure relate to an artificial intelligence (AI) based mediated multimodal communication system (MMCS) for scaling up and provide an access to professional experts in real time or on demand. More specifically, when a professional of a certain expertise level or competence level is unable or unavailable to provide a resolution to a received request, the AI MMCS executes operations to scale up an access to a next level professional expert on demand or in real time.

### BACKGROUND

Conventionally, an end user seeking some kind of a professional assistance may do so by scheduling an appointment with an entity or an enterprise offering such services. For instance, the entities or the enterprises offering such services may include a healthcare ecosystem or a vehicle service station or an equipment service or maintenance station. In case of an emergency situation, for example, a medical emergency or a vehicle breakdown or an equipment breakdown, the end user may communicate and coordinate with a corresponding professional expert, for example, a healthcare expert or a mechanic or an equipment maintenance or service provider and may seek an assistance to overcome the emergency situation. However, seeking the assistance from the corresponding aforementioned professional experts may include coordinating with the respective professional expert, for example, the healthcare expert or the mechanic or the equipment maintenance or service provider, may not only be complex and time consuming, but also cumbersome as the end user may need to communicate or coordinate with more than one professional expert to seek immediate assistance. When time is critical factor, such as the emergency situation, instantaneous real time communication and coordination with multiple professionals, to seek the desired assistance, may be challenging.

The limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and a method to scale up an access to a professional expert in real time or on demand, is described. In an embodiment, the system and method may include a communicatively couple arrangement of an input data source, an artificial intelligence (AI) mediate multimodal communication system (MMCS), a professional experts system and an external data source. The input data may be sourced from multiple data sources that may assimilate information or data and be represented by the input data source. The AI MMCS may include multiple engines, models, circuits executing multiple logics and code, to implement an execution specific operations or functions. The AI MMCS may execute operations, such as receiving data from multiple input data sources, determining multiple attributes of the received data in response to a processing of the received data, based on the determined multiple attributes, determine a domain from multiple domains, and determine an area of expertise from multiple areas of expertise.

In an embodiment, the AI MMCS may execute operations, such as based on the received data and domain specific data from multiple external data sources (e.g., knowledge packs), the AI MMCS may execute operations to determine a resolution. The resolution may be based on an analysis by the multiple engines, models, circuits executing decision logics, rules, code, etc., on the received data and the domain specific data from the external data sources. Further, when the resolution provided by the AI MMCS is insufficient or needs improvisation, the AI MMCS may execute operations to initiate a consultation with domain and expertise specific one or more professionals. Further, the AI MMCS may execute operations, such as based on the determined domain, the area of expertise and an expertise level of one or more professionals, computing a score to numerically quantify multiple professionals, based on the computed score, determine a professional who is competent to provide a resolution, initiating a communication with the determined professional, in response to the initiated communication, determining a status of an availability or an unavailability of the determined professional, and when the determined professional is unavailable or is unable to provide the resolution, scale-up an access to select a professional with a higher level of expertise from the multiple professionals based on the computed score. The expertise level of the professionals may be determined and accessed by the AI MMCS from the professional experts system.

In an embodiment, the AI MMCS may execute operations, such as when the determined professional is available to provide the resolution, enable a mediated intermodal communication with the determined professional who is competent to provide the resolution. Further, when the determined professional is unavailable or unable to provide the resolution, enable the mediated intermodal communication with the next level expert professional who is competent to provide the resolution. Further, the mediated intermodal communication may be a voice assisted communication and a video assisted communication. Further, the input data source may include multiple computing devices, multiple smart devices, etc., that may be configured to work independently or in cooperation. The attributes associated with the data received form the input data source may include information related to a type of event and a severity of the event.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is an illustration showing an environment that enables scaling up an access to a professional expert, according to an exemplary embodiment.

FIG. 2 is an illustration showing a system that enables scaling up an access to a professional expert, according to an exemplary embodiment.

FIG. 3 is an illustration showing a deployment of AI MMCS in a healthcare ecosystem, according to an exemplary embodiment.

FIG. 4 is a flow diagram showing a process to scale up an access to a professional expert, according to an exemplary embodiment.

FIG. 5 shows an exemplary hardware configuration of computer 500 that may be used to implement components of a system 200 and 300 to scale up an access to a professional expert, according to exemplary embodiments.

### DETAILED DESCRIPTION

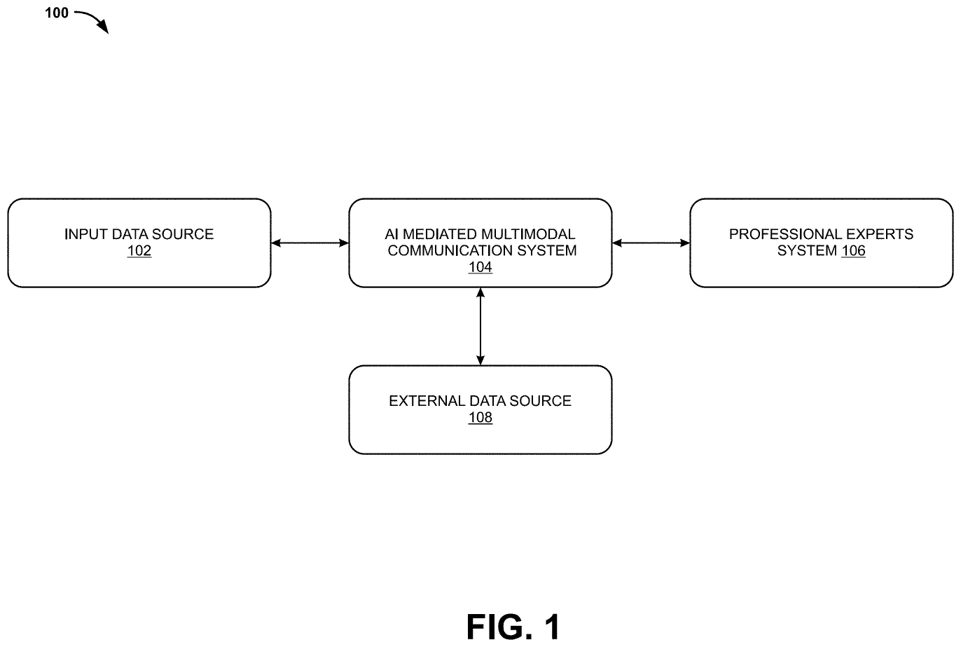

FIG. 1 is an illustration showing an environment 100 that enables scaling up an access to a professional expert, according to an exemplary embodiment. FIG. 1 is an illustration showing an environment 100 that enables scaling up an access to a professional expert on demand or in a real time. In an embodiment, the environment 100 shown includes a communicatively coupled arrangement of an input data source 102, an artificial intelligence (AI) mediated multimodal communication system (MMCS) 104, a professional experts system 106 and an external data source 108. The input data source 102 may assimilate information or data from multiple sources and may be configured to transmit or send such assimilated information or data to the AI MMCS 104. A mechanism or a process of sending the data to the AI MMCS 104 may be automated or be aided via human assistance. For example, the input data source 102 may include computing devices that may be deployed with an application, for example, a mobile application that may facilitate connecting and communicating with the AI MMCS 104. The human assistance may correspond to an end user using the computing devices to manually capture or record the data or information and send this data or information to the AI MMCS 104. In an embodiment the AI MMCS 104 may include a framework (not shown) of an independent or a cooperative working of multiple engines, models, one or more circuits executing one or more logics, and one or more code, etc., that may facilitate an execution of multiple operations on the received data. In an embodiment, the AI MMCS 104 may execute operations to enable automatic resolutions. For instance, the AI MMCS 104 may process the data or information received from the input data source 102, augment the received data with domain specific data or information from the external data source 108 (e.g., knowledge packs) and execute operations to determine and provide automatic resolutions. In an embodiment, when the automated resolutions recommended or provided by the AI MMCS 104 may be insufficient or an end user may need additional assistance or further improvisation of the resolution, the AI MMCS 104 or the end user determines that the resolution may need further improvisation, the AI MMCS 104 may execute operations for connecting with the professional expert who may be able to provide the resolution.

In an embodiment, the AI MMCS 104 including multiple engines, models, one or more circuitries executing one or more logics, one or more code, etc., may facilitate an execution of operations either independently or in cooperation with each other. An engine may correspond to a special purpose program or an executable code that enables execution of one or more core functions or operations. A model or a mechanism of modelling may include creating or improvising a functional or operational aspect of a system or one or more feature of the system by referencing an existing or known knowledge base. The outcome of the modeling process is to learn or train continually from the data, modifications in the data and optimize or improvise the functional or operational aspects of the system or one or more features of the system. The operational aspects of the system may provision execution of operations that may include determination, analysis, quantification, and visualization. The process or mechanism for the modeling may be automated through a continual process of training the model with the data from multiple sources. The engines, the models, one or more circuitries executing one or more logics, one or more code, etc. may implement an execution of the one or more core functions or operations based on configured one or more rules and/or one or more sequence of sequence of steps to produce specific outcomes.

In an embodiment, the professional experts system 106 may interface with multiple sources of information and store the information related to multiple professional experts. In the subject specification, the terms professional experts or professionals may be used interchangeably and may correspond to personnel who are associated with one or more domains, one or more areas of expertise, and may include a multitude level of skills and competence for handling specific tasks and/or providing resolutions. The data associated with the professionals may include information related to experience, skills and expertise, and the nature of assistance that the professionals may be able to provide on demand or in real time and may be represented by a corresponding attributes of the data.

In an embodiment, the external data source 108 may interface and assimilate information or data from multiple external data repositories. For example, the data stored in the multiple external repositories may include information related to a health of an individuals, an inspection or maintenance schedule of a building, a maintenance schedule of an equipment, data related to schedule, and historical information related to vehicle servicing, etc. In operation, the AI MMCS 104 may be configured to receive the data from the input data source 102. The AI MICS 104 may execute operations to make multiple determinations. For example, such determinations may include determining attributes of the received the data, determining a domain from the multiple domains, determining an area of expertise from multiple areas of expertise, determining an expertise level of a professional from multiple professionals, computing a score based on the aforementioned determinations, determining the professional who may be competent to provide a resolution based on the computed score, initiating a communication with the determined professional, determining an availability of the professional and based on the availability of the determined professional, enabling a multimodal communication between the professional and the individual seeking resolution. In an embodiment, when the determined professional is unavailable, the AI MMCS 104 may execute operations to scale up and provide an access to select a next level expert professional based on the computed score. When the next level expert professional is available to provide the desired resolution, the AI MMCS 104 may enable the multimodal communication with the next level expert professional and the individual or end user seeking resolution.

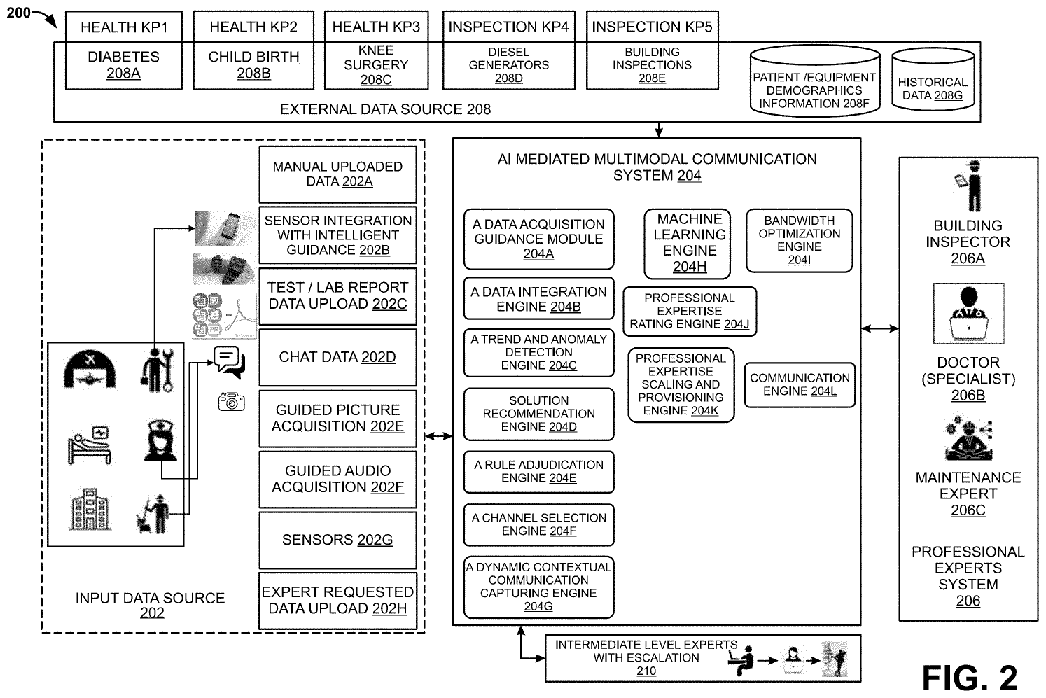

FIG. 2 is an illustration showing a system 200 that enables scaling up an access to a professional expert, according to an exemplary embodiment. FIG. 2 is an illustration showing a system 200 to enable scaling up an access to a professional expert on demand or in real-time. In an embodiment, the system 200 includes a communicatively coupled arrangement of an input data source 202, an AI MMCS 204, a professional experts system 206, an external data source 208 and an intermediate level of experts with escalation 210. The input data source 202 may include multiple sources of diverse information or data. The input data source 202 may be configured to communicate with the AI MMCS 204 and transmit or send the data to the AI MMCS 204 automatically or via a human assistance. For instance, the input data source 202 may represent the data that may be sent from one or more computing devices to the AI MMCS 204. For example, such computing devices may include multiple computer systems, smart devices, smart phones, mobile devices, laptops, personal digital assistants, tablet computers, or a combination thereof. The input data source 202 may facilitate or provision connecting with the AI MMCS 204 via an application installed on the computing devices. The application on the computing devices may include, for example, a mobile application that may provide an interface for inputting information or data in multiple formats, sending the information to the AI MMCS 204 and enable multimodal communication by connecting with the available professional experts to seek assistance or resolution on demand or in real time.

In an embodiment, the input data source 202 may include the data or information that may be inputted via the human assistance. For example, such data inputs may include text messages, instantaneous messages from other messenger applications, a guided audio, or video inputs, etc. Further, the human assisted input information may include the data or information requested by the professional experts in real time or on demand. For example, the human assisted input information or data may include a combination of, for example, a manual uploaded data 202A, a sensor data integration with intelligence guidance 202B, an uploading data of related to test/lab data 202C, a communication or chat data 202D assimilated from multiple communication channels, a guided picture acquisition 202E, text messages, a guided audio acquisition 202F or video inputs, data assimilated from sensors 202G, a professional or a subject matter expert requested data upload 202H or any other data as requested on-demand by the professional experts, etc.

In an embodiment, the input data source 202 may further include the data or information that may be automatically assimilated using the smart devices. For example, such smart devices may include a combination of multiple, for example, sensors, smart watches, smart monitoring, and alerting devices, etc. In such a scenario, the AI MMCS 204 may be configured to automatically monitor and record one or more vital parameters by the smart devices. The one or more vital parameters may represent attributes of the data or information that may be received by the AI MMCS 204. In an embodiment, the smart devices may be configured to cooperatively execute operations with the computing devices. In such instances, the input data source 202 may include data monitored from the smart devices and the information input via the human assistance. The monitored data and the input information may be assimilated and sent to the AI MMCS 204 for an execution of further operations or processing. In an embodiment, the AI MMCS 204 may execute operations to enable providing automatic resolutions. For instance, based on the data or information receive from the input data source 202 and data or information augmented from the external data source 208, the AI MMCS 204 may execute operations to make suitable determinations, execute decision logics and rules and provide resolutions automatically.

Referring to FIG. 2, there is shown that the AI MMCS 204 may include a data acquisition guidance engine 204A, a data integration engine 204B, a trend and anomaly detection engine 204C, a solution recommendation engine 204D, a rule adjudication engine 204E, a channel selection engine 204F, a dynamic contextual communication capturing engine 204G, a machine learning engine 204H, a bandwidth optimization engine 204I, a professional expertise rating engine 204J, a professional expertise scaling and provisioning engine 204K, and a communication engine 204L. In an embodiment, the AI MMCS 204 may implement an execution of multiple engines, models, multiple circuits executing one or more logics and one or more code, etc., to implement an execution specific operations or functions. The multiple engines, the models, the circuits executing one or more logics, one or more code, etc., may execute the operations independently or in cooperation with each other.

In an embodiment, the data acquisition guidance engine 204A may execute operations to provide multiple ways of guided inputs to an end user. Such guided inputs may be for inputting additional data or specific information. The data received via the input data source 202 may be processed and by cooperatively working with the engines in the AI MMCS 204, further determinations may be made, if additional data or specific information may be useful for providing the resolution. Upon making such determinations, the data acquisition guidance engine 204A may execute operations to provide visual cues, text, voice, or video based instructions to the user for inputting additional information or data. Upon receiving the requested additional data, the engines, the models, the one or more circuits executing one or more logics and one or more code, etc., the AI MMCS 204 may further process the additional data and facilitate an execution of the specific operations or functions.

In an embodiment, the data integration engine 204B may execute operations to integrate the data from multiple diverse sources of information. Upon receiving inputs from the input data source 202, the engines in the AI MMCS 204 may execute operations to make determinations if integrating additional data with the received input data may be useful or vital for further processing and providing resolutions. Upon making such determinations, the data integration engine 204B may access a corresponding specific information or the data from the external data source 208. The data integration engine 204B may be configured to determine the attributes of the data stored in the external data source 208 and the attributes of the data associated with the request or the information input by the user. Upon such determination, the data integration engine 204B may cooperatively work with the other engines and execute operations to integrate the data. One such integrated data, the engines, models, the circuits executing one or more logics and one or more code, etc., in the AI MMCS 204 may execute further operations to provide the resolution.

In an embodiment, the trend and anomaly detection engine 204C may execute operations to determine specific trends or anomalies in the data or the information. The trend and anomaly detection engine 204C may execute operations to continually learn from the data and the modifications in the data, make determinations and execute further operations based the determinations. For example, consider a scenario where the AI MMCS 204 is configured to monitor vital parameters, such as blood pressure, heart beat rate, blood sugar level, etc., of a patient. In such a scenario, the AI MMCS 204 may be configured to automatically receive information or data from multiple inputs data sources that may be represented by the input data source 202. Such input data sources may include multiple, for example, sensors, health trackers and monitoring devices, computing devices, etc. In an embodiment, the trend and anomaly detection engine 204C may execute operations to track or monitor and continually learn from the received information or the data from the patient. When the patient exhibits or has normal health conditions, there may be a specific pattern or trend associated with the monitored vital parameters of the patient. In an embodiment, the AI MMCS 204 may be configured to determine and provide automatic resolutions. For instance, when the patient exhibits normal health conditions, the trend and anomaly detection engine 204C in cooperation with the solution recommendation engine 204D may be enabled to automatically notify the patient or the patient attendant that no modifications in dosage levels of medication, diet and lifestyle changes may be necessary. Further, when the monitored vital parameters are within acceptable threshold levels, for example, less than 5% of the acceptable threshold levels, the AI MMCS 204 may use this information, augment a domain/patient specific data or information from the external data source 208 and execute operations to automatically provide resolutions. The patient or the patient attendant may be notified that the monitored vital parameters are within permissible or acceptable threshold levels and based on historic information associated with the corresponding patient, the AI MMCS 204 may provide automated resolutions including recommendations that no further changes may be necessary. In an embodiment, when the automated resolutions recommended or provided by the AI MMCS 204 may be insufficient or needs further improvisation or the patient needs may need additional assistance, the AI MMCS 204 may execute operations for connecting with the professional expert who may be able to provide the resolution.

In an embodiment, the consider a situation when there is a change or slight modifications in the health condition, such changes or modifications may be reflected in the corresponding data. For example, the specific pattern or the trend associated with the monitored vital parameters of the data may change or be modified. In an embodiment, the trend and anomaly detection engine 204C may be configured to detect such changes or modifications in the data or data pattern or trend associated with the specific parameters of the data or information.

In an embodiment, the solution recommendation engine 204D may execute operations to make recommendations or suggestions of one or more solutions to the end user. For example, consider the above described situation when the trend and anomaly detection engine 204C detects or determines the change or modification in the specific data pattern or the trend associated with the vital parameters of the data or information. When the information or the trend associated with the vital parameters are slightly above acceptable or permissible threshold levels, for example, in the range of 5% to 10% above the acceptable or permissible threshold values, the AI MMCS 204 may be enabled to provide automatic resolutions. For example, such automated resolutions may include recommendations for seeking assistance of a nurse. The nurse may further receive instructions from the AI MMCS 204 that may include, for example, making slight modifications to the recommended diet or decreasing the salt intake or adding additional supplements to control the vital parameters. In an embodiment, when the trend associated with the vital parameters are well above permissible or acceptable threshold values, for instance, greater than 20% of the permissible or acceptable threshold values, the AI MMCS 204 may suggest further measures or provide additional solutions. For instance, such aforementioned instances are detected by the AI MMCS 204, the solution recommendation engine 204D working cooperatively with the trend and anomaly detection engine 204C may execute operations to provide recommendations or suggestions to the patient or the patient attendant. For example, such recommendations may include modifying dosage levels of medications upon consulting with a healthcare professional, modifications in diet, changes in lifestyle, seeking immediate assistance of a healthcare professional, when certain monitored parameters are above acceptable threshold values, etc. In an embodiment, the solution recommendation engine 204D may be configured to provide multiple solutions including recommendations of multiple healthcare professionals based on their level of expertise. In an embodiment, the recommended solutions and other vital information and data may be augmented at each level and shared with the healthcare professionals. For example, such other vital information may include historical information of the patient, consultation history with important insights or special markers that may be associated with medical events, etc.

In an embodiment, the rule adjudication engine 204E may execute operations to determine one or more rules from multiple rules that may need to be implemented, based on circumstances or situations. For example, based on the data received from the input data source 202, the engines, the models, the one or more circuitries executing one or more logics, one or more code, etc., in the AI MMCS 204 may execute operations to determine attributes of the data or information and determine the domain, the area of expertise, the level of expertise of the professional, etc. The rule adjudication engine 204E in cooperation with the other engines, models, circuitries, etc., may determine and execute one or more specific rules. Based on the execution, the AI MMCS 204 may further execute specific operations to provide resolution to the received request.

In an embodiment, the channel selection engine 204F may execute operations to select one or more communication channels. The selection of the one or more communication channels may enable communication between the users and the professional experts on the professional experts system 206. Based on the nature of the request from the user and cooperative working of the channel selection engine 204F with the other engines, models, one or more circuitries executing one or more logics, one or more code, etc., in the AI MMCS 204, the channel for communication between the users and the professional experts may be established.

In an embodiment, the dynamic contextual communication capturing engine 204G may execute operations to determine contextual information from the communication between the users and the professional experts. For example, when the user requests to consult or seek assistance with the professional experts from the professional experts system 206, the channel selection engine 204F in cooperation with the other engines may select a channel for communication. The dynamic contextual communication capturing engine 204G may execute operations to determine the context of the communication based on the attributes of the context in the communication. The dynamic contextual communication capturing engine 204G may be configured to execute operations, for example, modeling the real time or on demand based conversations with different mathematical models. Such modeling of the real time or on demand conversations using AI MMCS 204 may enable determine topics in human interactions or conversations, executing logic to perform context evaluation, etc.

In an embodiment, the dynamic contextual communication capturing engine 204G may be configured with a combination of multiple decision logic and/or rules for determining and/or classifying contexts from the conversations. The dynamic contextual communication capturing engine 204G may be trained and implemented using multiple deep neural network systems. The dynamic contextual communication capturing engine 204G may be trained to adaptively improve operational efficacies for executing decision logic. For example, executing decision logic and/or functions such as, determining contexts in the conversations, classifying the determined contexts, and storing the contexts in the external data source 208. In an embodiment, the context of a conversation may refer to an instance or a combination of information structures. The dynamic contextual communication capturing engine 204G may be trained with training dataset and multiple mathematical models may be generated and stored in the external data source 208. Based on the data source and the context of the conversations, the unified dataset may be modeled based on multiple mathematical models stored in the external data source 208.

In an embodiment, contextual information associated with the conversations may be determined based on the modeling, analysis, and representation of the conversations by the dynamic contextual communication capturing engine 204G. For example, the dynamic contextual communication capturing engine 204G may execute operations to fragment or divide the conversations. Further, based on an execution of the mathematical modeling techniques, multiple concepts from the conversations may be extracted by the dynamic contextual communication capturing engine 204G. Furthermore, based on an execution of the mathematical modeling techniques, multiple aspects, and features in the conversations at any given instance in the conversations may be extracted by the dynamic contextual communication capturing engine 204G and represented as stochastic heuristics. The dynamic contextual communication capturing engine 204G may execute operations to comprehend the contexts of other conversations (e.g., historical conversations, prior recorded conversations, etc.) stored in the external data source 208 and access such contexts from any prior conversations.

In an embodiment, the machine learning engine 204H may execute operations to continually learn from the input data source 202 and the external data source 208. The machine learning engine 204H may work in cooperation with the rule adjudication engine 204E and execute operations to modify or update the rules. Further, the machine learning engine 204H may work in cooperation with the dynamic contextual communication capturing engine 204G and continually analyze and make determinations based on the captured contexts from the communication between the users and the professional experts.

In an embodiment, the bandwidth optimization engine 204I may execute operations to optimize the bandwidth based on an availability of the professional experts to provide resolution on demand or in real time. For example, upon receiving a request from the input data source 202, the bandwidth optimization engine 204I in cooperation with the machine learning engine 204H may execute operations to determine availability or unavailability of the professional experts for providing resolution to the specific queries. The bandwidth optimization engine 204I in cooperation with the dynamic contextual communication capturing engine 204G may be configured to continually learn the specific instances of the information including the availability or unavailability of the professional experts. Further attributes of the information or the data may include, for example, regular working hours, preference to availability or unavailability or to respond to emergencies beyond regular working hours, preferred mode or a frequency of availability or an unavailability for consultation, turnaround time based of level of expertise of the professional, timeliness and quality of the provided solution or resolution, etc.

In an embodiment, the professional expertise rating engine 204J may execute operations to numerically quantify the professional experts. The professional expertise rating engine 204J may be configured to execute operations of determining the domain, the area of expertise and the level of expertise of the professionals. Further, based on the domain, the areas of expertise and the level of expertise, the professional expertise rating engine 204J may execute operations for computing a score. The computed score may enable to numerically quantify the professional based on multiple attributes. Numerical quantification may correspond to a mechanism that precisely quantifies the qualitative, quantitative and expertise aspects of the professional. The score corresponding to the professional may be computed on various attributes and may further be augmented with feedback from end users, subject matter experts and other sources of information including industry benchmarks.

In an embodiment, the computed score may be associated with the professional experts that may be used by other engines in the AI MMCS 204. Further the computed score may further be optimized or improved by adding additional multi-dimensional information. For example, such additional multi-dimensional information may be associated with providing expert resolutions to the received requests that may include attributes, such as an availability or unavailability beyond regular working hours, preferred mode or a frequency of availability or an unavailability for consultation, turnaround time based of level of expertise of the professional, timeliness and quality of the provided solution or resolution based on emergency or severity of an event, etc. In an embodiment, the machine learning engine 204H may continually learn information, and cooperatively work with the professional expertise rating engine 204J to optimize or improve the numerical quantification or the ratings of the professional experts.

In an embodiment, the professional expertise scaling and provisioning engine 204K may execute operations of scaling up and provide access to a next level expert professional. Scaling up or scale up may correspond to an increase in an extent of reachability or access to an expertise or a professional with higher level of experience or expertise in the area of interest or domain. For example, when a professional expert with certain level of expertise is not able to (e.g., unable) or not available to (e.g., unavailable) provide the resolution, the professional expertise scaling and provisioning engine 204K in cooperation with the professional expertise rating engine 204J and the machine learning engine 204H may determine and provide scaling up access to the next level expert professional. Such scaling up provision to access the next level of expertise may provide opportunities for instantaneous resolution on demand or in real time. In an embodiment, the next level expert professional may be provisioned to be selected based on the score computed by the professional expertise rating engine 204J.

In an embodiment, the communication engine 204L may execute operations to enable communication between the end users and the professional experts via the AI MMCS 204. In an embodiment, upon determining the availability of the professional expert or provisioning selection of the next level professional expert, the communication engine 204L in cooperation with the channel selection engine 204F, the bandwidth optimization engine 204I, and the machine learning engine 204H may establish a communication channel between the end user requesting the resolution (e.g., represented by the input data source 202) and the available professional expert on the professional experts system 206. Once the communication channel is established, the end user and the professional expert may communicate via voice, video, text messages, or a combination thereof.

In an embodiment, the professional experts system 206 may store information related to the professional experts from specific domains and/or areas of expertise (e.g., 206A, 206B, 206C, etc.). For example, the professional experts system 206 may include data stores or repositories storing information related to the professionals. For example, such as information may be related to functional or operational skills of the professionals, a level of expertise, specific domain knowledge, a frequency of availability for providing resolution during emergencies, timeliness, and an effectiveness of the resolution, etc. In an embodiment, the professionals may include healthcare professionals, vehicle mechanics, building maintenance professionals, service providers, subject matter experts, etc. The information on the skills and expertise may be associated with, for example, patient care, servicing and maintenance of vehicles, inspection, service and maintenance of buildings, service, and maintenance of equipment, etc. Each professional expert may have multiple levels of skills and expertise in specific areas and/or domains. The expertise rating/value models 204J in the AI MMCS 204 may continually be trained to learn the multiple level of skills and expertise of each professional.

In an embodiment, the external data source 208 may include information from multiple data sources. The multiple data sources may correspond to knowledge packs (KPs) that may include additional information. Such additional information may be related to historical information, data or information assimilated from multiple sources based on different situations, data or information related to different situations and handled by the professionals of different expertise levels, etc. For instance, such information may be associated with healthcare related data (e.g., Health KP 1 208A, Health KP 2 208B, and Health KP 3 208C), equipment service and maintenance data related to equipment (e.g., Inspection KP 4 208D), building assets layout, inspection, and maintenance data related to buildings (e.g., Inspection KP 5 208E), other services related data, specific domain areas and subject matter experts related data, patient/equipment demographics information (e.g., 208F), historical data (e.g., 208G), etc. The healthcare related data may include, for example, patient demographics information, all type of historical information and data associated with the patients, etc. In an embodiment, the engines and/or the models, and the one or more circuits, etc., (e.g., 204A through 204L) in the AI MMCS 204 may be configured to access the information and the data from the external data source 208, execute operations to determine relevancy and integrate the determined data with the information or data received from the input data source 202 and use this integrated data for further processing and analysis.

In an embodiment, intermediate level of experts with escalation 210 may facilitate or provision handling escalation or additional requests. For example, such escalation or additional requests may be provided by end users or by the professional experts. For instance, when the professional expert is interested in viewing specific or a subset of information in a large data set, the AI MMCS 204 may facilitate providing access to the intermediate level of experts with escalation 210, who may provide the subset of information that is requested by the professionals. In an embodiment, when the AI MMCS 204 is not able to determine or process repeated requests from the end users for connecting with professionals of higher expertise, the intermediate level of experts with escalation 210 may intervene and augment such requests with supplemental information or data with the requests. Such supplemental information or data may be processed by the AI MMCS 204 and further enable scaling up access to the professionals with much higher level of expertise.

In operation, the engines, the models, the one or more circuitries executing one or more logics, one or more code, etc., (e.g., 204A through 204L) in the AI MMCS 204 may be configured to receive and process information from multiple sources of information including diverse data sources or data repositories. Based on the nature of the requests, the engines, the models, the one or more circuits executing one or more logics, one or more code, etc. (e.g., 204A through 204L) in the AI MMCS 204 may work in cooperation to determine a type and a nature of request via the input data source 202. When the professional is unavailable or not able to provide resolution to the user request, the engines, the models, the one or more circuits executing one or more logics, one or more code, etc. (e.g., 204A through 204L) in the AI MMCS 204 may be configured to execute operations to determine the professional with next or a higher level expertise who may be able to provide resolution the end user. The AI MMCS 204 may be configured to execute operations to provide scaling up a selection of the next level expert professional, who may be competent to provide resolution to the end user.

For instance, consider a scenario, where the AI MMCS 204 may be deployed to manage sales and service tasks and activities of electrical generators. The sales and service (S&S) tasks and activities of the electrical generators may be provided by multiple different vendors in a specific geographical area. Now, let us consider that, as a part of an annual maintenance contract (AMC), the S&S tasks and activities of the electrical generators may include timely service and maintenance to enable uninterrupted functioning of the electrical generators. The AI MMCS 204 may receive such aforementioned information and may execute operations to automate certain tasks and activities related to the servicing of the electrical generators. The engines, the models, the one or more circuits executing one or more logics, one or more code, etc., (e.g., 204A through 204L) of the AI MMCS 204 may receive the data including information related to S&S activities and tasks from the multiple different vendors that may be represented as the input data source 202. Further, the aforementioned engines, models, and the one or more circuits executing one or more logics, one or more code, etc., (e.g., 204A through 204L), etc., may be trained to process the received information and create suitable tasks on timely basis. For example, the AI MMCS 204 may be configured to execute operations, for example, to automate tasks and activities, such as scheduling service and maintenance and sending notifications and reminders to vendors or third-party service providers collaborating cooperatively with the vendors on the maintenance and service related tasks.

In an embodiment, the AI MMCS 204 may execute operations to automatically generate and instantiate communications related to service and maintenance of the electric generators and send such information to the vendors or the third-party service providers. The AI MMCS 204 may further execute operations to cooperatively work with the professional experts system 206 to determine technicians who may have diverse expertise levels and may be available to address service the electrical generator. Upon such determination, the AI MMCS 204 may execute operations to notify on the scheduled service and maintenance of the electrical generator. Further, the AI MMCS 204 may be enabled to provide automatic resolutions, based on the information related to the scheduled service and maintenance of the electrical generator. For instance, the solution recommendation engine 204D in cooperation with the machine learning engine may execute 204H may execute operations to provide automatic resolutions. The AI MMCS 204 may use or receive data related to scheduled maintenance (e.g., 202) and augment the received data with domain specific data or information from external data source (e.g., 208D), execute operations to make determinations and enable or provide automatic resolutions. For example, the automatic resolutions may include providing recommendation to replace certain parts of the electrical generator that may be subject to time based wear and tear. For example, such parts may include rubber parts such as bushes, belts, some plastic parts, etc. Further, the automated resolutions may include recommendations related to identifying dirty or loose connections that may be impacting the functioning the battery packs in the electrical generator. Further, the automated resolutions may include recommendations related to examining or identifying low level of coolants, leaky parts or worn out parts, etc. In an embodiment, when the automatic resolution is determined as insufficient by the end user or when the AI MMCS 204 may determine that the resolution provided needs improvisation, the AI MMCS 204 may execute operations to determine and connect with a corresponding professional expert from the professional experts system 206 to seek further inputs for further improvising the resolution.

Let us consider a scenario when the service cycle for one of the electrical generators was inadvertently missed, and the operation of the electrical generator was interrupted on an event of a breakdown. Now in such a circumstance, the personnel managing the electrical generator may try to seek assistance from the vendor who may be responsible for S&S activities of the electrical generator. The personnel managing the electrical generator may seek assistance of the corresponding vendor responsible for S&S activities. Upon connecting, the corresponding vendor may further provision connecting the personnel seeking assistance with a junior technician who may be able to provide resolution and fix the broken electrical generator.

Now consider that the junior technician reaches the location to fix the broken electrical generator and upon further investigation, the junior technician determines that he may need additional assistance. For example, such additional assistance may include advanced tools, replacement parts of the electrical generator, etc. Further the junior technician may further determine the need for a further assistance of a senior technician, who may be more skilled and experienced technician to manage and provide resolutions based on the nature and type of the breakdown. Based on such determination, the junior technician may determine to seek assistance of the senior technician and connect to the AI MMCS 204 via the mobile application on his device. Upon connecting with the AI MMCS 204, the junior technician may provide details on the model, type, parts, etc., including specific inputs related to the breakdown of the electrical generator. The engines, the models, and the one or more circuitries executing one or more logics, one or more code, etc., (e.g., 204A through 204L), etc., in the AI MMCS 204 may execute operations to process the received inputs (e.g., 202) including the data related to the breakdown, determine the attributes of the received data, and may provide further guided instructions to the junior technician.

In an embodiment, the AI MMCS 204 may provide guided instructions, for example, to capture pictures of the specific parts of the electrical generator, and enter any additional information related to the specific parts or any other the worn out parts of the electrical generator. For example, the junior technician may provide inputs in multiple formats, for example, text or multimedia content, such as photographs, audio recordings, video recordings, etc. Upon receiving the requested information, the AI MMCS 204 may execute operations to process the received additional information. Further, the AI MMCS 204 may execute operations to facilitate connecting with the professional experts system 206 and further make determinations on choosing or selection the senior technician from the professional experts system 206. In an embodiment, the senior technician from the professional experts system 206 may be able to further improvise the resolution provided. Based on the domain, the details of the received information associated with the breakdown of the electrical generator, the expertise level of the professionals on the professional experts system 206, the AI MMCS 204 may execute operations to compute a score.

In an embodiment, the score may enable numerically quantifying the professional based on multiple attributes. Based on the computed score, the AI MMCS 204 may determine and select one or more senior technicians that may be able to provide resolution. Further, the AI MMCS 204 may initiate a communication with a first senior technician. The first senior technician may provide an indication on his availability and when the first senior technician confirms an availability, the AI MMCS 204 may enable mediated intermodal communication between the first senior technician and the junior technician. In an embodiment, when the first senior technician is unavailable or not able to provide a resolution, the first senior technician may provide such an indication that may be received by the AI MMCS 204. Upon determining the unavailability of the first senior technician the AI MMCS 204 may provision connecting with a second senior technician or scale up provide access to a higher expertise level technician. In an embodiment, the higher expertise level technician is competent to provide the resolution, which may be determined by the AI MMCS 204 via the computed scores. Further, the junior technician may seek assistance of either the second senior technician or the higher expertise level technician and provide resolution including fixing the broken electrical generator.

In an embodiment, when the specific components or specific parts of the electrical generator needs to be replaced, the AI MMCS 204 may be configured to determine such instances and communicate with the enterprise. The enterprise may receive the communication, validate the requirements, and make suitable arrangements to dispatch the specific components or the specific parts of the electrical generator. Such quick actions may enable fixing the broken down electrical generator in real time or on demand, without any delay. In another embodiment, the professional experts system 206 may provision a mechanism that may include providing an availability of the professionals for providing the resolution. In such circumstances, the AI MMCS 204 may assign the task to one of the junior technician, the senior technician, etc., and notify the vendor or the third-party service provider about the assignment of the task.

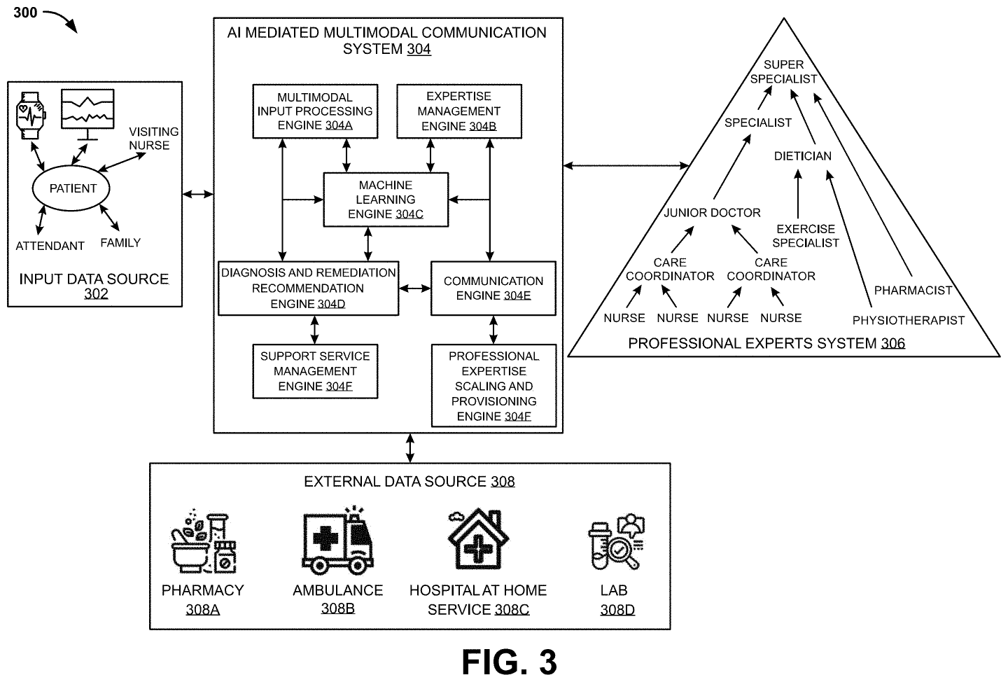

FIG. 3 is an illustration showing a deployment of AI MMCS in a healthcare ecosystem, according to an exemplary embodiment. FIG. 3 is described in conjunction with FIG. 2 and FIG. 1. FIG. 3 is an illustration showing a communicatively coupled arrangement of a system 300 including an input data source 302, an AI MMCS 304, a professional experts system 306, and an external data source 308. In an embodiment, the AI MMCS 304 may be deployed in a healthcare ecosystem and may be configured to remotely monitor a patient under observation. The AI MMCS 304 may implement an execution of multiple decision logics, engines, models, one or more circuitries and/or code executed by the one or more circuitries, to execute specific operations or functions. In an embodiment, the AI MMCS 304 may be deployed to provide remote monitoring and management of the patient under observation. In an embodiment, the AI MMCS 304 may be enabled to determine a resolution based on an information or data received from the input data source 302 and a domain specific data augmented from the external data source 308. For instance, based on the data or information receive from the input data source 302 and data or information augmented from the external data source 308, the AI MMCS 204 may execute operations to make suitable determinations, execute decision logics and rules and provide resolutions automatically. The AI MMCS 304 may be configured to determine whether the resolution provided may need further improvisation. For example, the improvisation of resolution may correspond to involving one or more professionals with different levels of expertise and seek expertise and multidimensional inputs and recommendations for improvising the resolution provided.

In an embodiment, the AI MMCS 304 may include a multimodal input processing engine 304A, an expertise management engine 304B, a machine learning engine 304C, a diagnosis and remediation recommendation engine 304D, a communication engine 304E, and a support service management engine 304F. The aforementioned engines (e.g., 304A, 304B, 304C, 304D, 304E and 304F) in the AI MMCS 304 may be configured to execute operations either independently or in cooperation with each other. In an embodiment, some of the engines (e.g., 304A, 304B, 304C, 304D, 304E and 304F) may execute integrated operations of the engines, models, one or more circuitries, and the one or more circuits, etc., (e.g., 204A through 204L), shown and described in FIG. 2. The execution of integrated operations may include integrating or combining execution of operations of one or more engines, models, one or more circuitries, and the one or more circuits, etc., (e.g., 204A through 204L) to enable optimization or better utility of the overall system 300.

In an embodiment, the multimodal input processing engine 304A may be configured to execute integrated operations of the engines in the AI MMCS 204. For example, the multimodal input processing engine 304A may execute operations associated with the data acquisition guidance engine 204A, the data integration engine 204B, and the trend and anomaly detection 204C. The multimodal input processing engine 204 may execute operations for processing and normalizing the data received from the input data source 304. Upon normalizing the data, the multimodal input processing engine 304A may execute operations to determine multiple attributes of the data. The attributes of the data may be associated with the domain, the area of expertise, the level of expertise of the professionals, type of request, severity of the request, etc. The multimodal input processing engine 304A may further execute operations to determine specific trends or anomalies in the data or information. The operational efficacies and the execution of the operations of the above reference engines (e.g., 204A, 204B, and 204C) is as described with reference to FIG. 2.

In an embodiment, the expertise management engine 304B may be configured to execute integrated operations of the engines in the AI MMCS 204. For example, the expertise management engine 304B may execute integrated operations associated with the rule adjudication engine 204E, the bandwidth optimization engine 204I, the professional expertise rating engine 204J, and the professional expertise scaling and provisioning engine 204K. The operational efficacies and the execution of the operations of the above reference engines (e.g., 204E, 204I, 204J and 204K) are as described with reference to FIG. 2.

In an embodiment, the machine learning engine 304C may execute operations of continually learning from the input data source 304, the communication engine 204L, and the external data source 308. The machine learning engine 204H may work in cooperation with the rule adjudication engine 204E and execute operations to modify or update the rules. Further, the machine learning engine 304C may work in cooperation with the dynamic contextual communication capturing engine 204G and continually analyze and make determinations based on the captured contexts from the communication between the users and the professional experts.

In an embodiment, the diagnosis and remediation recommendation engine 304D may execute integrated operations of the engines in the AI MMCS 204. For example, the diagnosis and remediation recommendation engine 304D may execute operations of the solution recommendation engine 204D and the rule adjudication engine 204E. The diagnosis and remediation recommendation engine 304D in cooperation with the multimodal input processing engine 304A and the machine learning engine 304C may execute operations to determine trend and anomalies in the data or information received from the patient under observation. Based on the determined type and severity of one or more anomalies, the diagnosis and remediation recommendation engine 304D may provide intermediate recommendations that may be used by the attendant or the nurse or the healthcare professional treating the patient under observation. The operational efficacies and the execution of the operations of the above reference engines (e.g., 204D and 204E) are as described with reference to FIG. 2.

In an embodiment, the communication engine 304E may be configured to execute integrated operations of the engines of the AI MMCS 204. For example, the communication engine 304E may execute operations associated with the channel selection engine 204F, the dynamic contextual communication capturing engine 204G, and the communication engine 204L. The operational efficacies and the execution of the operations of the above reference engines (e.g., 204F, 204G, and 204L) is as described with reference to FIG. 2.

In an embodiment, the professional experts system 306 may include data repositories or data stores, storing the data and information related to the domain expertise, areas of expertise, skills, competency level, etc., associated with the professionals. For example, such professionals may include expertise and may be from multiple domains such as healthcare, automobile, retail, real estate, equipment, and components manufacturing industries, etc. In an embodiment, the information of skills and expertise related to the professionals may include patient care, vehicles, building and associated equipment, etc. Each of the professionals may have a multitude of skills and levels of expertise. The expertise management engine 304B in the AI mediated multimodal communication system 304 may continually be trained to learn the multitude of skills and expertise level of each professional.

Referring to FIG. 3, there is shown the professionals related to healthcare domain that may include nurses, care coordinators, physiotherapist, pharmacists, junior doctor, exercise specialist, dieticians, specialists, super specialists, etc. In an embodiment, when a professional of certain expertise level is unavailable to provide the resolution or is not competent to provide the resolution, the AI MMCS 304 may execute operations to determine the professional with next or higher expertise level who may be able to provide resolution. In an embodiment, the AI MICS 304 may execute operations to provide scaling up the expertise level and providing access to the scaled up expert professional.

In an embodiment, the AI MMCS 304 may cooperatively execute operations with healthcare ecosystem services (e.g., 308). For example, such healthcare ecosystem services may include pharmacy 308A, ambulance 308B, hospital at home 308, and laboratory services (e.g., Lab 308D). In an event of an emergency or when the patient may need immediate assistance, the AI MMCS 304 may facilitate communication between the patient or attendant of the patient and the healthcare ecosystem services (e.g., 308) and provide assistance or resolution on demand or in real time.

For example, consider a scenario of a deployment of the AI MMCS 304 to monitor a patient under home healthcare. In an embodiment, the input data source 302 may be represented by data that is provided automatically or via the human assistance. The automatic data provisioning may be enabled by the smart monitoring devices. The smart monitoring devices may include sensors, smart watches and similar devices that may be configured to monitor vital parameters such as body temperature, blood pressure, pulse, respiratory rate, oxygen saturation levels, etc. The human assisted data provisioning may include inputting data using the computing device. For instance, an attendant, a visiting healthcare personnel, a nurse, etc., attending the patient under home healthcare may provide inputs or deed data via a mobile application installed on the computing device. The data that may be input may include, for example, manually uploading the requested information or data, manually collecting data from sensors or smart monitoring device with intelligence guidance, manually inputting information related to laboratory test reports, a chat data, a guided picture acquisition, a guided audio acquisition, providing the data requested by expert professionals, etc. Such automatically monitored or human assisted or the data that includes integrated information representing the input data source 302 may be transmitted or sent to the AI MMCS 304 for further processing and analysis.

In an embodiment, upon receiving the data from the input data source 302 at the AI MMCS 304, the multimodal input processing engine 304A may execute operations to determine the attributes of the received data. With reference to the above described scenario of monitoring the patient in the home healthcare environment, the multimodal input processing engine 304A may determine that the domain is related to healthcare and may further execute operations to determine the area of expertise of one or more healthcare professionals. In an embodiment, the AI MMCS 304 may be configured to enable providing automatic resolutions. For instance, when the patient exhibits normal health conditions, the diagnosis and remediation recommendation engine 304D may be enabled to automatically notify the patient or the patient attendant that no modifications in dosage levels of medication, diet and lifestyle changes may be necessary. Further, when the monitored vital parameters are within acceptable threshold levels, for example, less than 5% of the acceptable threshold levels, the AI MMCS 304 may use this information, augment data or information from the external data source (e.g., 308) and execute operations to automatically provide resolutions. The patient or the patient attendant may be notified that the monitored vital parameters are within permissible or acceptable threshold levels and based on historic information associated with the corresponding patient, the AI MMCS 304 may provide automated resolutions including recommendations that no further changes may be necessary. In an embodiment, when the automated resolutions recommended or provided by the AI MMCS 304 may be insufficient or the patient needs may need additional assistance, the AI MMCS 304 may execute operations for connecting with the professional expert who may be able to provide the resolution or provide further inputs for improvising the resolution.

In an embodiment, upon determining the area of expertise, the expertise management engine 304B may execute operations to determine the expertise level of one or more of the healthcare professionals from the professional experts system 306. For example, the professional expertise system may include healthcare professionals such as nursing professionals, special care coordinator professionals, junior expertise level healthcare professionals (e.g., junior doctors), mid expertise level healthcare professionals (e.g., specialists), high expertise level healthcare professionals (e.g., super specialists), etc. The healthcare personnel may monitor the vital signs and determine if they can resolve or help the user. In an embodiment, based on the determined domain, the area of expertise and the expertise level of the one or more healthcare professionals, the expertise management engine 304B may compute a score. Based on the computed score, the healthcare professional who may be competent to observe the data or the information and provide further recommendations may be determined.

For instance, when the determined healthcare professional may further determine that the patient under home healthcare may need advice or assistance of the junior doctor or the specialist, the determined healthcare professional may provide an indication of such determination. The machine learning engine 304C in cooperation with the expertise management engine 304B and the professional expertise scaling and provisioning engine 304G may receive this input from the healthcare professional, and based on the computed score, execute operations to determine the next level of healthcare professional, for example, the junior doctor or the specialist who may be able to assist the patient. Upon determining the healthcare professional at such next level, the AI MMCS 304 may execute operations to send the monitored information or the data of the patient to the determined junior doctor or the specialist at such next level. Upon receiving a confirmation from the determined junior doctor or the determined specialist, the communication engine 304E in the AI MMCS 304 may initiate a communication with the determined healthcare professional. In response to the initiated communication, the determined healthcare professional may respond by providing an indication of a status of their availability. In an embodiment, the determined healthcare professional is unavailable to attend the patient or provide an immediate resolution. In such circumstances, the machine learning engine 304C in cooperation with the expertise management engine 304B and the professional expertise scaling and provisioning engine 304G may execute operations to provide scaling up to provide access to the next level healthcare professional, who may be competent to provide resolution or attend the patient. For example, when the nurse or the care coordinators or the junior doctors are not available or not able to provide resolution, the AI MMCS 304 may execute operations to scale up and seek access or assistance of the specialists or the super specialists.

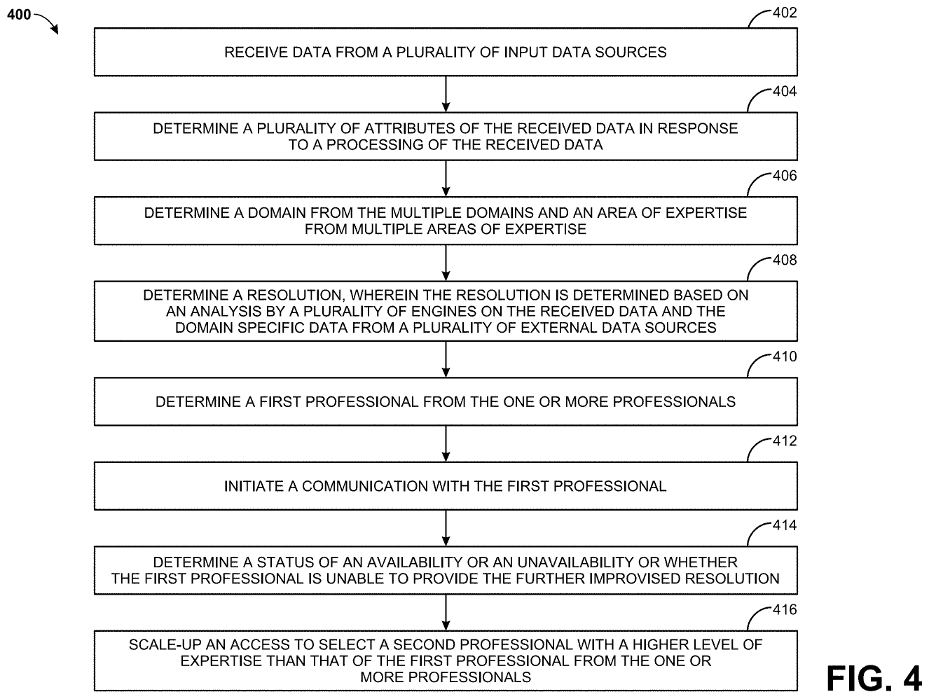

FIG. 4 is a flow diagram showing a process to scale up an access to a professional expert, according to an exemplary embodiment. FIG. 4 is described in conjunction with FIG. 2 and FIG. 3. At 402, data is received from multiple input data sources (e.g., by executing operations as described with reference to 202 and 302). The received data is processed by a processor of a computer implementing the process 300. At 404, multiple attributes of the received data are determined in response to the processing of the received data (e.g., by executing operations as described with reference to 204 and 304). At 406, based on the determined multiple attributes, a domain from the multiple domains and an area of expertise from multiple areas of expertise is determined. At 408, a resolution in response to the received data is determined, wherein the resolution is determined based on an analysis of the received data from the plurality of the input data sources and the domain specific data from a plurality of external data sources (e.g., by executing operations as described with reference to 204 and 304). At 410, a first professional from the one or more professionals is determined, upon determining that the resolution requires a further improvised resolution (e.g., by executing operations as described with reference to 204 and 304). The first professional is competent to provide the further improvised resolution. At 412, a communication with the first professional is initiated (e.g., by executing operations as described with reference to 204 and 304). At 414, in response to the initiated communication, a status of an availability or an unavailability or is unable to provide the further improvised resolution, by the first professional is determined (e.g., by executing operations as described with reference to 204 and 304). At 416, when the first professional is unavailable or is unable to provide the further improvised resolution, a scale-up of an access to select a second professional with a higher level of expertise than that of the first professional from the one or more professionals (e.g., by executing operations as described with reference to 204 and 304). The expertise level of the one or more professionals may be determined and accessed from the professional experts system (e.g., by executing operations as described with reference to 206 and 306). In an embodiment, the scaling-up of access to the higher level of expertise professional than that of the determined professional is based on the computed score. The operational efficacies of the execution of the steps (e.g., 402, 404, 406, 408, 410, 412, 414 and 416) in the process 400 are operations execute by the respective engines, models, the one or circuits executing one or more code, as described with reference to FIG. 2 and FIG. 3.

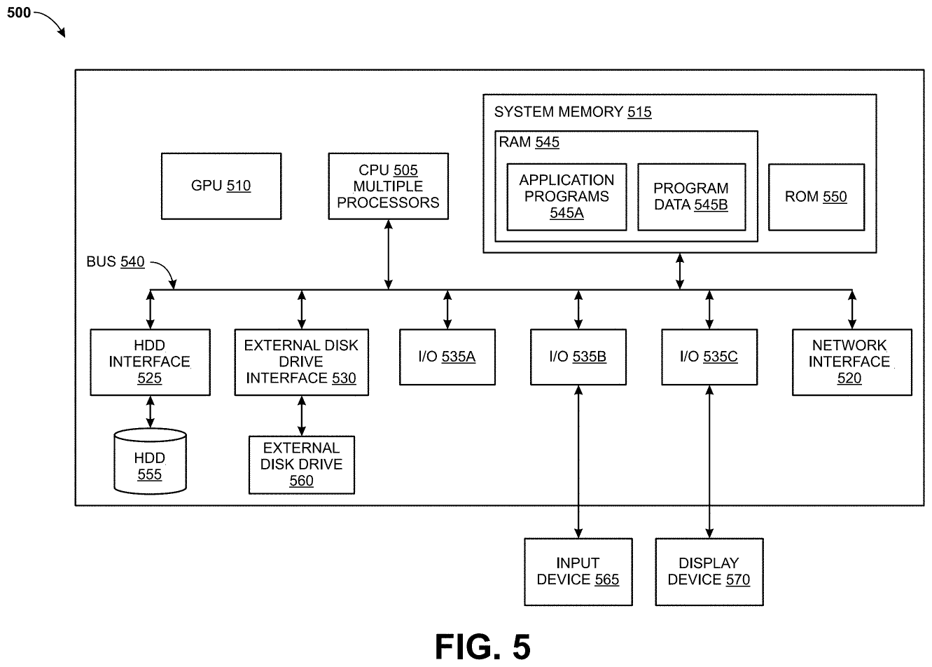

FIG. 5 shows an exemplary hardware configuration of computer 500 that may be used to implement components of an AI MMCS 200 and 300 to scale up an access to a professional expert, according to exemplary embodiments. The computer 500 shown in FIG. 5 includes CPU 505, GPU 510, system memory 515, network interface 520, hard disk drive (HDD) interface 525, external disk drive interface 530 and input/output (I/O) interfaces 535A, 535B, 535C. These elements of the computer are coupled to each other via system bus 540. The CPU 505 may perform arithmetic, logic and/or control operations by accessing system memory 515. The CPU 505 may implement the processors of the exemplary devices and/or system described above. The GPU 510 may perform operations for processing graphic or AI tasks. In case computer 500 is used for implementing exemplary central processing device, GPU 510 may be GPU 510 of the exemplary central processing device as described above. The computer 500 does not necessarily include GPU 510, for example, in case computer 500 is used for implementing a device other than central processing device. The system memory 515 may store information and/or instructions for use in combination with the CPU 505. The information and/or instructions may be for implementing the execution of the engines in AI MMCS 204 and 304, as described in FIG. 2 and FIG. 3. The system memory 515 may include volatile and non-volatile memory, such as random-access memory (RAM) 545 and read only memory (ROM) 550. A basic input/output system (BIOS) containing the basic routines that helps to transfer information between elements within the computer 500, such as during start-up, may be stored in ROM 550. The system bus 540 may be any of several types of bus structures including a memory bus or memory controller, a peripheral bus, and a local bus using any of a variety of bus architectures. The computer may include network interface 520 for communicating with other computers and/or devices via a network.

Further, the computer may include hard disk drive (HDD) 555 for reading from and writing to a hard disk (not shown), and external disk drive 560 for reading from or writing to a removable disk (not shown). The removable disk may be a magnetic disk for a magnetic disk drive or an optical disk such as a CD ROM for an optical disk drive. The HDD 555 and external disk drive 560 are connected to the system bus 540 by HDD interface 525 and external disk drive interface 530, respectively. The drives and their associated non-transitory computer-readable media provide non-volatile storage of computer-readable instructions, data structures, program modules and other data for the general-purpose computer. The relevant data may be organized in a database, for example a relational or object database.

Although the exemplary environment described herein employs a hard disk (not shown) and an external disk (not shown), it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

Several program modules may be stored on the hard disk, external disk, ROM 550, or RAM 545, including an operating system (not shown), one or more application programs 545A, other program modules (not shown), and program data 545B. The application programs may include at least a part of the functionality as described above.

The computer 500 may be connected to input device 565 such as mouse and/or keyboard and display device 570 such as liquid crystal display, via corresponding I/O interfaces 535A to 535C and the system bus 540. In addition to an implementation using a computer 500 as shown in FIG. 5, a part or all the functionality of the exemplary embodiments described herein may be implemented as one or more hardware circuits. Examples of such hardware circuits may include but are not limited to: Large Scale Integration (LSI), Reduced Instruction Set Circuits (RISC), Application Specific Integrated Circuit (ASIC) and Field Programmable Gate Array (FPGA).

One or more embodiments are now described with reference to the drawings, wherein like reference numerals are used to refer to like elements throughout. In the following description, for purposes of explanation, numerous specific details are set forth to provide a thorough understanding of the various embodiments. It is evident, however, that the various embodiments can be practiced without these specific details (and without applying to any networked environment or standard).

As used in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made considering the above detailed description. Rather, the scope is to be determined by the following claims, which are to be interpreted in accordance with established doctrines of claim construction.

1. A system, comprising:
a processor;
a memory storing instructions, which when execute by the processor, perform operations to:
receive data from a plurality of input data sources;
process the received data by the processor of the system;
determine a plurality of attributes of the received data in response to the processing of the received data;
based on the determined plurality of attributes, determine:
a domain from a plurality of domains; and
an area of expertise from a plurality of areas of expertise;
determining a resolution in response to the received data, wherein the resolution is determined based on an analysis of the received data from the plurality of input sources and a domain specific data from a plurality of external data sources;
upon determining that the resolution requires a further improvised resolution, determine a first professional from the one or more professionals, wherein the first professional is competent to provide the further improvised resolution;
initiate a communication with the first professional;
in response to the initiated communication, determine a status of an availability or an unavailability of the first professional or whether the first professional is unable to provide the further improvised resolution; and
when the first professional is unavailable or is unable to provide the further improvised resolution, scale-up an access to select a second professional with a higher level of expertise than that of the first professional from the one or more professionals.

2. The system of claim 1, wherein based on the determined domain, the area of expertise and an expertise level of one or more professionals, compute a score to numerically quantify the one or more professionals.

3. The system of claim 1, wherein when the first professional is available to provide the resolution, enable a mediated intermodal communication with the first professional, wherein the first professional is competent to provide the resolution.

4. The system of claim 1, wherein when the first professional is unavailable or is unable to provide the resolution, enable the mediated intermodal communication with the second professional with the higher level of expertise than that of the first professional from the one or more professionals, wherein the second professional is competent to provide the resolution.

5. The system of claim 3, wherein the enabled mediated intermodal communication is selected from a group consisting of a voice assisted communication and a video assisted communication or a combination thereof.

6. The system of claim 1, wherein the plurality of attributes of the received data includes information associated with a type of event and a severity of the event.

7. The system of claim 1, wherein the plurality of input data sources include one or more of a manual uploaded data, an integrated sensor data, data associated with a test/lab data upload, an integrated chat data from multiple communication channels, a data including guided picture acquisition, a plurality of text messages, a guided audio or video acquisition, data assimilated from a plurality of sensors, an expert requested data upload, data requested by on-demand professional experts, sensors, smart watches, smart monitoring, and alerting devices.

8. The system of claim 1, further comprising:
determine a trend associated with the received data; and
in response to determining a modification in the trend, provide one or more suggestions including seeking assistance of the one or more professionals.

9. The system of claim 1, further comprising: determine a contextual information from the mediated intermodal communication, wherein the contextual information is determined based on a modelling, analysis, and representation of one or more conversations in the mediated intermodal communication.

10. The system of claim 1, further comprising: based on the availability or the unavailability of the one or more professionals, optimize a bandwidth of the one or more professionals.

11. A computer implemented method comprising:
receiving data from a plurality of input data sources;
processing the received data by a processor of the computer;
determining a plurality of attributes of the received data in response to the processing of the received data;
based on the determined plurality of attributes, determining a domain from a plurality of domains and an area of expertise from a plurality of areas of expertise;
determining a resolution in response to the received data, wherein the resolution is determined based on an analysis of the received data from the plurality of input sources and a domain specific data from a plurality of external data sources;
upon determining that the resolution requires a further improvised resolution, determining a first professional from the one or more professionals, wherein the first professional is competent to provide the further improvised resolution;
initiating a communication with the first professional;
in response to the initiated communication, determining a status of an availability or an unavailability or whether the first professional is unable to provide the further improvised resolution; and
when the first professional is unavailable or is unable to provide the further improvised resolution, scaling-up an access to select a second professional with a higher level of expertise than that of the first professional from the one or more professionals.

12. The computer implemented method of claim 11, wherein based on the determined domain, the area of expertise and an expertise level of one or more professionals, compute a score to numerically quantify the one or more professionals.

13. The computer implemented method of claim 11, wherein when the first professional is available to provide the resolution, enabling a mediated intermodal communication with the first professional, wherein the first professional is competent to provide the resolution.

14. The computer implemented method of claim 11, wherein when the first professional is unavailable or unable to provide the resolution, enabling the mediated intermodal communication with the second professional with the higher level of expertise than that of the first professional from the one or more professionals, wherein the second professional is competent to provide the resolution.

15. The computer implemented method of claim 13, wherein the enabled mediated intermodal communication is selected from a group consisting of a voice assisted communication and a video assisted communication or a combination thereof.

16. The computer implemented method of claim 11, wherein the plurality of attributes of the received data includes information associated with a type of event and a severity of the event.

17. The computer implemented method of claim 8, wherein the plurality of input data sources include one or more of a manual uploaded data, an integrated sensor data, data associated with a test/lab data upload, an integrated chat data from multiple communication channels, a data including guided picture acquisition, a plurality of text messages, a guided audio or video acquisition, data assimilated from a plurality of sensors, an expert requested data upload, data requested by on-demand professional experts, sensors, smart watches, smart monitoring, and alerting devices.

18. The computer implemented method of claim 11, further comprising:
determining a trend associated with the received data; and
in response to determining a modification in the trend, providing one or more suggestions including seeking assistance of the one or more professionals.

19. The computer implemented method of claim 11, further comprising: determining a contextual information from the mediated intermodal communication, wherein the contextual information is determined based on a modelling, analysis, and representation of one or more conversations in the mediated intermodal communication.

20. The computer implemented method of claim 11, further comprising: based on the availability or the unavailability of the one or more professionals, optimizing a bandwidth of the one or more professionals.
